(19) United States
(12) Patent Application Publication
(10) Pub. No.: US 2003/0164309 A1
(43) Pub. Date: Sep. 4, 2003

(54) Method and device for deodorization and purification of exhaust gas or flue gas

(75) Inventors: Shinichi Nakamura, Osaka-shi (JP); Kunihiko Fukuzuka, Habikino-shi (JP); Jingo Nakazawa, Osaka-shi (JP)

Correspondence Address: Norman P. Soloway, HAYES SOLOWAY P.C., 130 W. Cushing Street, Tucson, AZ, 85701, US

(73) Assignee: OMEGA CO., LTD.

(21) Appl. No.: 10/314,507

(22) Filed: Dec. 9, 2002

(30) Foreign Application Priority Data
Jun. 10, 2002 (JP) 2002-169335
Dec. 28, 2001 (JP) 2001-402070

(51) Int. Cl. C02F 1/461

(52) U.S. Cl. 205/746; 423/237; 423/242.1

(57) ABSTRACT

A method and device for removing, deodorizing and purifying odor, smoke and harmful substances from exhaust gas or flue gas employs a water solution containing hypohalogen acid such as hypochlorous acid soda, an alkaline electrolyte such as potassium hydroxide or sodium hydroxide and a saline electrolyte such as sodium chloride, potassium chloride, sodium bromide or potassium bromide which is electrolyzed to produce an electrolytic water solution which is fed to a deodorizing tower and brought into contact with exhaust gas or flue gas to remove odor, smoke and harmful substances in the exhaust gas or flue gas.

### BACKGROUND OF THE INVENTION

1. Field of the Invention

The present invention relates to a method and a device for efficiently removing odor, smoke and harmful material from exhaust gas or flue gas emitted from, chemical devices, waste water treatment equipment, processes such as drying, incineration, and treatment of waste and human waste, cooking facilities such as restaurants, hospitals, elderly care facilities, offices, homes and entertainment centers such as game arcades, and for carrying out sterilization.

2. Description of the Related Art

Conventionally, odor, smoke and harmful material in exhaust gas emitted from chemical devices, waste water treatment equipment, processes such as drying, incineration, and treatment of waste and human waste, and cooking facilities such as restaurants have been absorbed using chemical agents such as a alkali or acidic solution as an absorbent, and then processed by method of absorbing with a packed tower, spray tower, wetted wall tower or stepped tower or bubble tower etc., or by adsorption equipment using granular adsorbent such as activated charcoal. These are all large scale installations, and require a lot of space. Also, deodorization and purification of exhaust gas or flue gas has a problem that depending on the composition of the exhaust or flue gas it is not possible to provide sufficient deodorization and purification unless a number of the above described methods are combined. If performance is lowered with degradation of the agents used, there is also a problem of increased costs due to replacement of the agents.

Tobacco smoke is also harmful to other people in the room besides the smoker. Not only does smoke cause lung cancer and stomach cancer, but tobacco smoke has also been judged to be a cause of sudden infant death syndrome (SIDS) in 60% of cases. Moreover, even when air cleaners which have begun to become widespread are used to deodorize and remove dust, it has become clear that there is a problem that it is not possible to remove and purify the bulk of those components that are considered most likely to be harmful in tobacco smoke, such as carbon monoxide and nicotine (Japan Electric Industry Association: Japan anti-smoking league, Dr. Masaaki Yamaoka, October 2001).

This applicant has disclosed, in Japanese Patent Laid-open No. Hei. 6-292713, a method of carrying out sterilization and purification of air inside a room by bringing air in the room into contact with electrolytic generated water. However, bad odor, smoke and harmful material in exhaust gas or flue gas, which is the subject at this time, cannot be dealt with sufficiently with methods proposed to date when there is a large amount of a heterogeneous component in high concentration. It is also very easy for harmful trihalomethane to be generated if some water soluble organic matter comes into contact with chlorine gas within the water, and with a low pH when salt water is electrolyzed there is a problem that more chlorine is generated than hypochlorous acid, which means that a lot of trihalomethane is generated.

The present inventor has applied for the following patents, relating to methods and devices for purification and sterilization using electrolysis of water used in a pool, 24-hour bath house, fish breeding tank, pond, or used as air conditioner water, car wash drainage, or for combined treatment:

(1) Japanese Patent Application No. Hei. 6-233739 “Water Purification Method and Purification Device”

(2) Japanese Patent Application No. Hei. 9-299084 “Water Quality Purification Method and Mechanism for Same”

(3) Japanese Patent Application No. Hei. 11-371314 “Deodorization and Purification Method for Exhaust Gas or Flue Gas”

(4) Japanese Patent Application No. 2000-168578 “Electrolytic Device”

(5) Japanese Patent Application No. 2001-369794 “Electrolytic Device”

(6) Japanese Patent Application No. 2001-402070 “Purification and Sterilization of Water etc.”

Among these inventions, purification and sterilization using electrolysis of pool water, bath water or air conditioner water is possible with (1) and (2), but a platinum plated titanium electrode having extremely high corrosion resistance is used as an anode of the electrolytic device, and there is a problem that when load is high bath voltage becomes high in a short time. With (3), it was possible to carry out more stable electrolysis with water having low conductivity by using a ferrite anode.

With (3) Japanese Patent Application No. Hei. 11-371314 “Deodorization and Purification Method for Exhaust Gas or Flue Gas”, a mixture such as bromine ions and chlorine ions at a molar ratio of approximately 6:4 was used as an electrolyte, and a hydrogen ion content (pH) of the electrolytic water produced was in a range of 6 to 9. However, with a hydrogen ion concentration (pH) in a range of 6 to 9, it was not possible to sufficiently remove mist such as protein, oil and fat and there was a problem of the possibility of chlorine gas being produced.

With (4) Japanese Patent Application No. 09-369487 “Electrolytic Device”, and (5) Japanese Patent Application No. 2000-168578 “Electrolytic Device”, it was possible to acquire long term durability three to five times that for a platinum plated titanium anode under the same conditions by using a ferrite anode through a novel terminal bonding method. It was also possible to increase current density.

With conventional salt water electrolysis, high purification and sterilization effects are achieved with pH tending towards the weak acid side, and electrolysis is carried out by adding acid to sodium chloride so as to become weakly acidic, but decomposition purification is difficult for dirt containing protein, grease and oil etc, and there was a problem of corrosion of pipe work components and heat exchangers etc. There was also a problem of generating trihalomethane due to the production of chlorine gas.

The object of the present invention is therefore to remove deodorizing and purifying odor, smoke and harmful material in exhaust gas or flue gas simply and with a comparatively small device, and to provide a method of sufficiently removing film such as protein, oil and grease while reducing the need for replacement of agents and replenishment of water while not having to worry about waste water after processing, and reducing the generation of trihalomethane etc. as byproducts.

### SUMARY OF THE INVENTION

In order to achieve the above-described object, the present invention is provided with means having the following basic structure:

(a) A water solution that is a mixture of an alkaline electrolyte such as caustic soda, and a neutral electrolyte such as sodium chloride, is electrolyzed, generated electrolytic water is led to absorption means (deodorizing tower) 2, and bad odor, smoke or harmful material is removed from exhaust gas or flue gas by bringing the electrolytic water into contact with the exhaust gas or flue gas. As the absorption means (deodorizing tower) 2, it is preferable to normally use a packed tower, spray tower, wetted wall tower, plate tower or bubble tower. It is possible to sufficiently remove films of protein oil and fats with a reduced need to replace agents and replenish water, and no wastewater which needs to be processed later, and with reduced generation of trihalomethane etc. as byproducts.

(b) A water solution being a mixture of any one or a plurality of an alkaline electrolytic group, such as caustic soda, caustic potash, or hypochlorous acid soda, and a neutral salt electrolytic group such as sodium chloride, potassium chloride, or sodium bromide is used as an electrolytic water solution for electrolysis.

(c) It is possible to produce alkaline washing and sterilizing water by adjusting the pH of a cleansing sterilized water produced by electrolyzing an electrolytic water solution in an electrolytic device 1 to between 8 and 13. With tobacco smoke (carbon monoxide and nicotine), under this condition carbon monoxide and nicotine are easily oxidized, made harmless, and dissolved in the alkaline washing and sterilizing water. In this case carbon monoxide becomes carbon dioxide, and carbonate is produced to lower pH, which means that it is necessary to replenish the alkaline electrolyte. It is possible to almost completely remove extremely high risk substances, such as 20,000 μg (78.7%) of carbon monoxide and 2,000 μg (7.9%) of nicotine which are the most abundant materials among the harmful substances in tobacco smoke.

(d) Electrolytic water solution that is a mixture of any one or a plurality of an alkaline electrolyte group, such as, caustic potash, hypochlorous acid soda or caustic soda, and a neutral salt electrolyte group, such as sodium chloride, potassium chloride, or sodium bromide is supplied to an electrolytic reactor and electrolyzed, generated electrolytic water is fed by a circulation pump 5 to absorption means (deodorizing tower) 2 by means of a water circulation path 4, and a shower spray is created.

In order to ensure good contact with the exhaust gas or flue gas in the absorption means (deodorizing tower) 2, electrolytic water is sprayed or a filler is used, or both are used in combination, after making contact with the exhaust gas or flue gas electrolytic water that has collected at the bottom of the absorption means (deodorizing tower) 2 is extracted, and electrolyzed while being repeatedly circulated by means of a water circulation path 4 provided between an electrolytic reactor (3) and the (deodorizing tower) 2. By repeatedly electrolyzing this shower spray water, deodorizing and purification effects are continuously refreshed and is possible to maintain exhaust gas or flue gas deodorizing and purification effects at peak condition.

(e) By providing the electrolytic reactor 3 with an anode that is a conductive metal with conductive ceramics or a vapor deposited or thermal sprayed film of conductive ceramics, or alternatively a vapor deposited or thermal sprayed film of diamond with additional conductivity, formed on a metallic surface of the conductive metal, and a cathode that is a conductive material such as stainless steel or titanium, it is possible to obtain an electrolytic reactor having excellent corrosion resistance. Alternatively, it becomes possible to make current density high and it is possible to decompose and purify matter that is difficult to degrade.

Bad smelling substances and harmful material in exhaust gas or flue gas produced at these facilities consists of decomposed fats and protein, as well as many organic materials containing N and S, and amines, ammonia, methyl thioalcohol, hydrogen sulfide, methyl sulfide, trimethylamine, acetaldehyde, propionic acid, normal butyric acid, carbon monoxide and nicotine etc. and are spread over an extremely wide range. As well as these bad smelling substances and harmful materials, various harmful microorganisms such as mold, bacteria, viruses etc. which can hardly be removed with a dust removal filter, a dust removal filter of a charged ion system using high voltage discharge, a deodorizing filter or a normal absorption tower, but the water resulting from electrolysis, cleansing and sterilization of the electrolytic water solution that is a combination of electrolytes in this application by the electrolytic reactor 3 can almost completely oxidize and dissolve these contaminants.

(f) The bad odor, smoke or harmful material in the exhaust gas or flue gas that is the processing object is bad odor, smoke or oil film etc. due to grilled meat, grilled fish or the like from a dining hall restaurant or foodstuff processing plant, cigarette smoke etc. from places where people congregate such as entertainment arcades, bad smelling material or harmful material from ventilation of hospitals or elderly care facilities, human waste and refuse disposal sites, living body type incineration, sewage treatment plants, and places for manufacturing and processing leather, pulp, fodder, fertilizer, plastic, and rubber, as well as harmful microbes such as mold, bacteria and viruses. It is also possible to apply the invention to a wide range of other uses.

(g) The bad odor, smoke or harmful material in the exhaust gas or flue gas that is the processing object is an organic solvent such as isopropyl alcohol, ethanol, toluene, xylene or benzine used in washing etc. at a factory, a chloride such as perchloroethylene, a fluoride based organic solvent such as fluon gas, or alcohol vapor produced at a storage building of a sake brewery or an aging cellar such as for whiskey or wine but since these cannot be discharged into the atmosphere, it is necessary to carry out complete purification processing.

With these factories and plants, exhaust gas is normally released into the atmosphere through a benthos scrubber or the like, and with this application it is possible to remove organic solvents contained within exhaust gas through oxidation and decomposition by simply subjecting this benthos scrubber water to electrolytic processing. These organic solvents, are materials that can be easily electrolyzed, and it is preferable to process these solvents by electrolysis at a high current density and with a high available chlorine concentration.

The present invention is an electrolytic device having an anode that is a conductive metal with conductive ceramics or a vapor deposited or thermal spray film of conductive ceramics, or alternatively a vapor deposited or thermal spray film of diamond with additional conductivity, formed on a metallic surface of the conductive metal, and a cathode that is a conductive material, which means that it is possible to carry out electrolysis with a high current density, simple oxidation and decomposition and purification become possible, and it is possible to continue highly efficient electrolysis stably for a long period of time.

(h) The bad odor, smoke or harmful material in the exhaust gas or flue gas that is the processing object is combustion exhaust gas, or sulfur oxide, such as smoke, nitroxide, carbon monoxide, hydrocarbon or soot and dust produced from a vehicle, a public works construction machine and its power source (such as a diesel engine), a boiler, a combustion furnace, etc., and these substances all contribute to smog and oxidants. With the present invention, it is possible to eliminate bad odor, smoke or harmful material in exhaust gas or flue gas with a simple combination of absorption means (deodorizing tower) 2 and an electrolytic reactor 3.

### BRIEF DESCRIPTION OF THE DRAWINGS

FIG. 1 is a system flow drawing showing a method of deodorizing and purifying exhaust gas or flue gas in accordance with the present invention;

FIG. 2 is a cross sectional drawing looking from the side and FIG. 2a is a plan view of an electrolytic device having a cylindrical anode and cathode in accordance with the present invention;

FIG. 3 is a flow drawing of a showering type deodorization test in accordance with the present invention;

FIG. 4 is a cross sectional drawing showing a state where an immersion type electrolytic device having a cylindrical anode 12 and a perforated cathode 13 is immersed in an electrolytic circulation water receiving tank 8 in accordance with the present invention; and

FIG. 5 is a flow drawing (in cross section) where contaminated air is attracted to the absorption means (deodorization tower) 2 by the blower (attraction fan) 17, subjected to oxidation processing and purification and sterilization by electrolytic sterilization and purification water and purified air is returned in accordance with the present invention.

### DESCRIPTION OF THE PREFERRED EMBODIMENTS

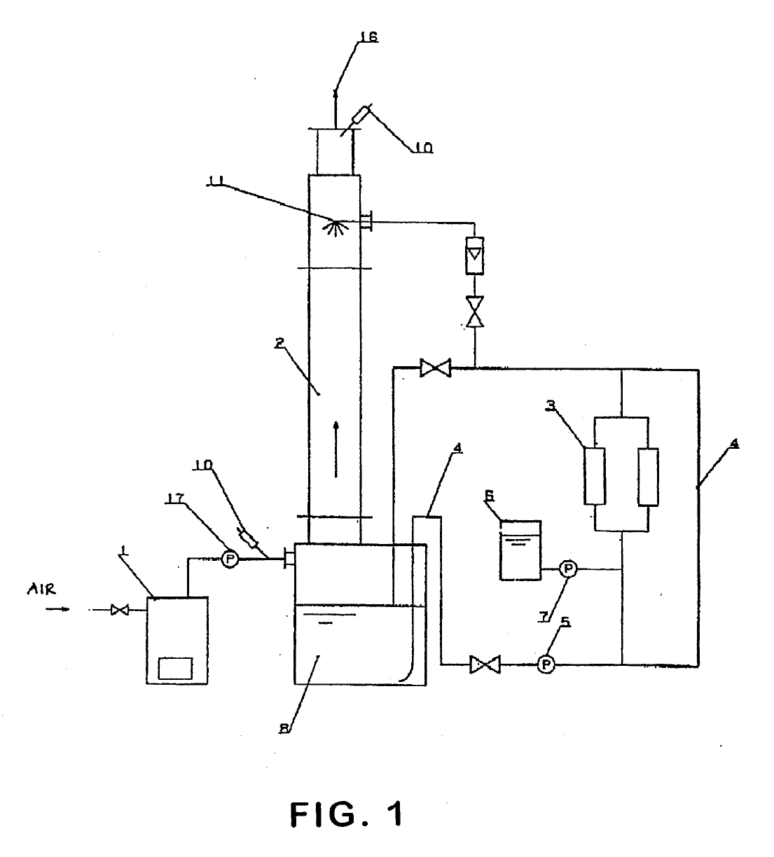

Embodiments of the present invention will now be described with reference to drawings based on examples. FIG. 1 is a flow sheet of a purification and sterilization water-producing unit in accordance with the present invention. A water solution such as hypochlorous acid soda, or an electrolytic water solution having dissolved salt such as a sodium chloride or potassium chloride is retained in an electrolytic water solution container 6. This electrolytic water solution is fed by a metering pump 7 to an electrolytic reactor 3, where it is subjected to electrolysis and mixed with mains water or service water to produce purification and sterilization water. This purification and sterilization water is fed to absorption means (deodorizing tower) 2 by means of a circulation pump and a water circulation path 4 and made into a spray by a spray nozzle 11. This spray water comes into contact with exhaust gas or flue gas within the absorption means (deodorizing tower) 2 to absorb bad odor and harmful material as well as oxidizing and dissolving them.

### EXAMPLE 1

The structure of the present invention will now be described in more detail. The embodiments of the present invention will be described with reference to drawings based on examples. FIG. 1 is a system flow drawing showing a deodorization and purification method for exhaust gas or flue gas. Exhaust gas or flue gas is directed from an exhaust gas or flue gas producing section 1 to the absorption means (deodorizing tower) 2 by a blower or suction fan. The exhaust gas or flue gas is then deodorized and purified by showering water from an electrolytic circulation water receiving tank 8 from an upper section of the absorption means (deodorizing tower) 2 using a spray nozzle or the like after being electrolyzed in the electrolytic reactor 3 by means of a circulation pump 5 and circulation path 4. The shower water falls into the electrolytic circulation water receiving tank 8 where it is retained, and a bad smelling component or harmful material absorbed in the shower water is decomposed and rendered harmless by strong oxidation due to available chlorine and reactive oxygen species within the shower water.

Shower water of the electrolytic circulation water receiving tank 8 is fed by the circulation pump 5 to the electrolytic reactor 3 where it is subjected to electrolytic processing again, bad smelling components or harmful material that remain are subjected to powerful anodic oxidation to decompose and purify, and at the same time available chlorine and reactive oxygen species are added to the shower water and this is fed by means of the circulation path 4 to the absorption means (deodorizing tower) 2 to deodorize and purify exhaust gas or flue gas.

As an example for eliminating bad odor emitted from a human waste treatment plant, 500 cc of human waste collected from a temporary toilet was placed in a 1 liter beaker wrapped with a band heater, put into the exhaust gas or flue gas generating section 1 of FIG. 1 (sealed container: volume 10 l) and heated to about 600° C. while stirring slowly with an agitator to produce bad odor. This is then fed to the absorption means (deodorizing tower) 2 by a cyclone fan having a capacity of 0.1 m³/min while simultaneously feeding water of the electrolytic circulating water solution receiving tank to the absorption means (deodorizing tower) 2 by means of the circulation path 4 and the circulation pump 5, making a shower and circulating again.

### Comparative Example 1

An amount of water of an electrolytic circulating water solution receiving tank 6 was 8 liters, and for the purposes of initial comparison a test was carried out to remove bad odor with only caustic soda water solution adjusted to pH 12 without operating the electrolytic reactor 3. Layer height of a filler Terarette for the absorption means (deodorizing tower) 2 was 0.8 m. The electrolytic water solution circulation rate was 0.8-1 l/min. Bad odor was transferred by absorption into the circulation water, but after a few minutes it became impossible to eliminate bad odor of exhaust gas at an exhaust port 7. If fresh water is supplied to the electrolytic circulating water solution receiving tank 6 and an amount corresponding to that portion is made to overflow out so that the electrolytic circulating water solution is partially refreshed it is possible to remove bad odor, but there is a problem that means must be prepared for removing bad odor transferred to the discharged water.

### EXAMPLE 2

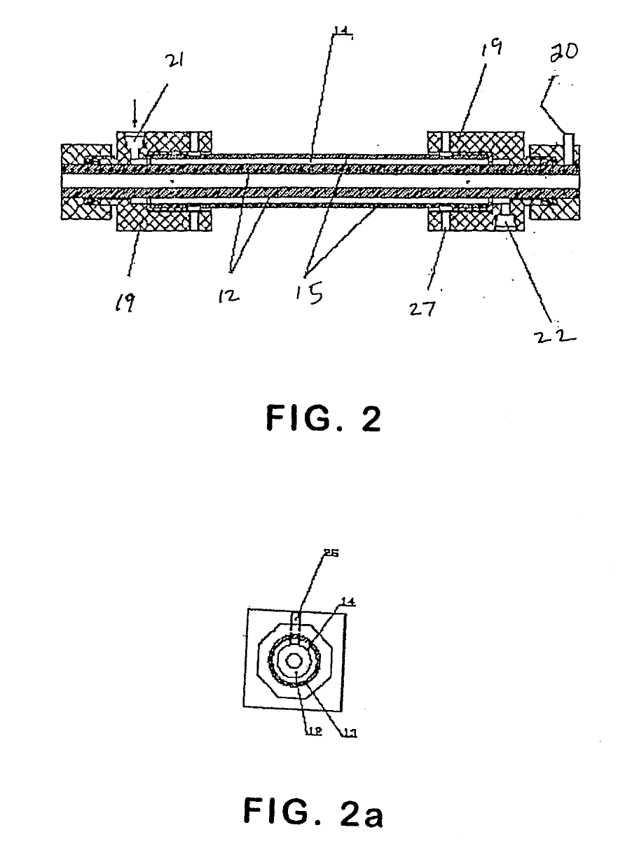

Next, a description will be given of the present invention for absorbing bad odor in circulating water by driving the electrolytic reactor 3 at the same time as removing bad odor in discharged water. An electrolytic reactor is shown in FIG. 2 and 2a and has an anode 12 that is a nickel ferrite tube with an outer diameter of 28 mm, a thickness of 8 mm and a length of 280 mm. An anode cathode distance is 4 mm, and a cathode 13 outside the anode tube 12 is an SUS316L pipe 15 having an outer diameter of 42.7 mm, a thickness of 3 mm, an electrode length of 280 mm, overall length 325.1 mm. A circulating water inlet 21 for introducing water solution containing halogen ions into an inter electrode reaction section 14 is provided in an electrode fixing section 19 formed from a nonconductive material at the base of the anode and electrode, and electrolytic sterilization and purification water outlet 22 is formed at an uppermost part of the electrode fixing section 19.

Electrolysis was carried out with electrolytic bath cells 2 arranged in parallel and a fixed current of 10A. Water solution that is a mixture of sodium chloride and sodium bromide and has been adjusted to pH 12 with caustic soda is put into an electrolytic water solution container 6 and filling controlled by a fixed capacity pump 7 so that electrical conductivity of the circulating water solution becomes constant.

Besides the electrolytic reaction, circulating water solution was circulated under the same conditions as for a comparative test, but there was almost no reduction in moisture due to evaporation and water was not replenished during this test. Electrolysis conditions were changed to find conditions under which it is possible to remove bad odor in exhaust gas emitted from the exhaust port 9. Detection of bad odor is sufficient by sense of smell, but ammonia within exhaust gas was measured using a gas concentration detector tube that is part of a Gas Measurement Kit 801 supplied by Gastec Corporation. With an ammonia concentration of 5 ppm or lower it was not possible to detect by sense of smell.

Also, when circulating the water solution under the same conditions as for the comparative example without electrolysis, ammonia concentration in the exhaust gas was 18 ppm, ammonia concentration in the circulating water solution was 32 ppm and COD was 22 ppm, but if water was circulated for three hours while performing electrolysis the ammonia concentration in the exhaust gas became 1 ppm or less, and could not be detected by sense of smell.

Electrolysis was carried out under electrolysis conditions of adding a mixture of sodium chloride and sodium bromide having a molar ratio of bromine ions to chlorine ions of 6:4 to the circulating water solution so as to be 0.1% with respect to the circulating water solution, with an electrical conductivity of about 2000 μs/cm, at 10A and 12V, and after three hours ammonia concentration of the circulating water solution was 2.4 ppm, COD was lowered to 5.3 ppm and purification of the circulating water solution was carried out to a sufficient extent.

### EXAMPLE 3

This example is a research report commissioned by the Okayama Prefectural Research Center, Food Industry Study Group (Dr. Satoshi Fukuzaki).

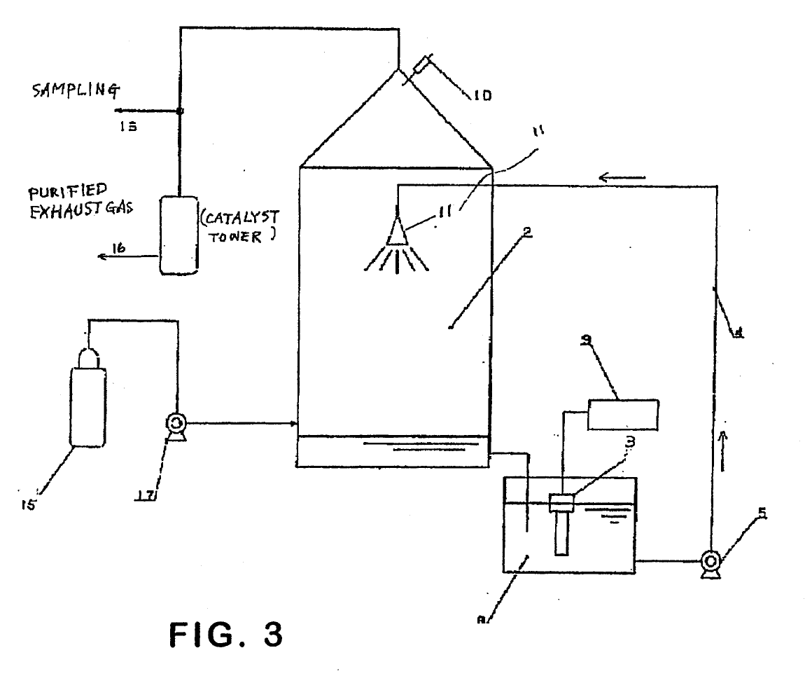

FIG. 3 is a flow drawing of a test using a shower ring type deodorizer of 501 capacity. Odorous substance from a bad smelling gas or harmful gas generating section 1 or a bad smelling gas container (such as a gas cylinder) 18 is extracted by a blower 17 and fed to the absorption means (deodorizing tower) 2 (volume 50 liters in this example). Bottled hydrogen sulfide was used as a bad smelling component produced by protein hydrolysis, and methyl thioalcohol was used as a bad smelling reference gas.

Testing was carried out under conditions of supply amount of bad smelling gas to a deodorizer in shower water of the electrolytic circulating water solution receiving tank 8 33L/min and shower jet amount 3.7L/min. As the shower water mains water, NaCl (0.1%) electrolytic water solution adjusted from mains water and NaNO₃ (0.1%) electrolytic water solution adjusted from mains water were used.

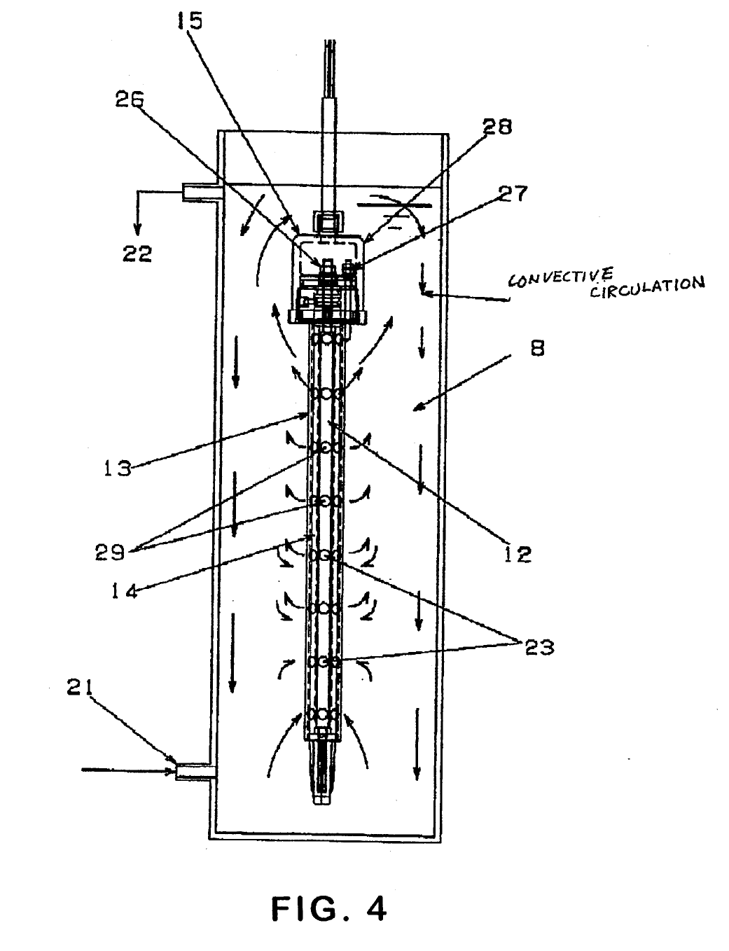

As the electrolytic reactor, here, electrolysis was carried out by directly immersing the immersion type electrolytic device 15 shown in FIG. 4 into shower water retained in the electrolytic water solution holding rank 8. Shower water being poured into the holding tank 8 from an inlet below holes 23 formed in the cathode is introduced to an anode-cathode reaction section (electrolytic path) 14 by an air lift effect and subjected to electrolysis. Gas such as hydrogen produced by the electrolysis forms bubbles and rises. Shower water subjected to electrolysis by this air lift effect rises and is naturally discharged from an outlet above the holes 23 formed in the cathode and shower water retained in the holding tank 8 is naturally circulated and mixed inside the tank.

Analysis: available chlorine concentration (conversion from hypochlorous acid concentration to Cl₂) was measured using an iodine titration method. OVA (ovalbumin) was measured using the Lowry-Folin method and a tray organic carbon analyzer (TOC-500A). Hydrogen sulfide and methyl thioalcohol were measured using a. detector tube (made by Komyo Rikagaku Ltd.).

As typical bad smelling components, deodorizing tests were carried out for hydrogen sulfide and methyl thioalcohol. Results of these tests are shown in Table 1. Deodorization results did not vary depending on whether it was mains water or NaNO₃ electrolytic water solution, and removal rate was 30-43%. In the case of using NaCl electrolytic water solution (available chlorine concentration 80 mg/l) the removal rate for hydrogen sulfide was 91-93%, and it was possible to remove almost all of the methyl thioalcohol.

TABLE 1
Deodorization results for showering tower using mains water, NaCl
dielectric water solution and NaNO₃ dielectric water solution

| | | Before | | |
|---|---|---|---|---|
| | Bad smelling | processing | After | Removal rate |
| Cleaner | component | (mg/l) | processing | (%) |
| water | Hydrogen | 1.7 | 1.2 | 29.4 |
| | sulfide | 3.3 | 2.2 | 33.3 |
| | methyl | 7.0 | 4.1 | 41.4 |
| | thioalcohol | 1.8 | 1.2 | 33.3 |
| NaCl (0.1%) | Hydrogen | 1.5 | 0.1 | 93.3 |
| electrolytic | sulfide | 3.0 | 0.2 | 93.3 |
| water | methyl | 7.0 | 0.6 | 81.4 |
| solution | thioalcohol | 1.8 | Not detected | 100 |
| NaNO₃ | Hydrogen | 1.7 | 1.1 | 35.3 |
| (0.1%) | sulfide | 3.3 | 2.2 | 33.3 |
| electrolytic | methyl | 7.0 | 4.0 | 42.9 |
| water | thioalcohol | 1.8 | 1.1 | 38.9 |
| | thioalcohol | | | |

※ Effective Concentration: 80 mg/l
deodorizing tower: 501
bad smelling gas: 33 liters/min
shower jet: 3.7 liters/min

### EXAMPLE 4

This example has the showering type deodorizer shown FIG. 3 applied to an amino acid manufacturing plant, and deodorization testing was carried out using alkaline sodium chloride electrolytic water solution (available chlorine concentration 110 mg/L). (1) Flow rate of deodorization hydrogen sulfide gas of hydrogen sulfide produced from anaerobic waste water treatment tank (methane fermentation tank): 65L/min (retention time: 0.8 min)

showering water amount: 3.7L/min

available chlorine concentration (HOCl) electrolytic water solution: 110 mg/L

For the purpose of comparison, testing was also carried out with a currently often used method (ozone gas+water shower). Results are shown in Table 2.

TABLE 2
Available chlorine concentration (HOCl) electrolytic water solution:
110 mg/L pH 9.5

| | Before | | |
|---|---|---|---|
| Bad smelling | deodorization | After deodorization | |
| component | (mg/l) | (mg/l) | Removal rate |
| Ozone gas (480 | 450 | 300 | 33.3 |
| mg/l) + water | | | |
| shower | | | |
| Electrolytic water | 450 | 16 | 96.4 |
| solution shower | | | |

(2) Deodorization of bad smelling gas produced from a raw material (grain) hydrolysis tank

Bad smelling gas flow amount: 33L/min (retention time: 1.5 min) Showering water amount: 3.7L/min

Available chlorine concentration (HOCl) electrolytic water solution: 140 mg/L

For the purpose of comparison, testing was also carried out with a currently often used method (ozone gas+water shower). Results are shown in Table 3.

TABLE 3
Available chlorine concentration (HOCl) electrolytic water solution:
110 mg/L pH 11

| | Before | Ozone gas | |
|---|---|---|---|
| Bad smelling | deodorization | (480 mg/l) + | Electrolytic water |
| component | (mg/l) | water shower | solution shower |
| methyl thioalcohol | 2.0 | 1.0 | N.D. |
| acetaldehyde | 6.5 | 2.5 | 2.0 |
| Dimethyl sulfide | 24 | 12 | N.D. |

### EXAMPLE 5

According to the “Labor Investigation Committee: Science of Smoking—Separation of Workplace for Smoker and Non-smokers” text book, the main harmful substances in smoking a single cigarette, in terms of gaseous phase components, are carbon monoxide 20,000 μg (78.7%), acetaldehyde 1,400 μg (5.5%), nitroxide 600 μg (2.4%), hydrogen cyanide 200 μg (0.8%), and ammonia 150 μg (0.6%), which gives a total gaseous phase component of 89.2%. The main substances in the 10.8% particle phase component are nicotine 2,000 μg (7.9%), catechol 460 μg (1.8%), and the balance primarily alkaloid type substances 200 μg (0.8%).

The most abundant of these namely the 20,000 μg (78.7%) of carbon monoxide and the 2,000 μg (7.9%) of nicotine, are harmful substances with an extremely high degree of risk. However, with currently used air cleaners it is mostly impossible to remove these harmful substances. The electrolytic sterilizing and purification water of this example can treat carbon monoxide and nicotine by respectively subjecting them to oxidation processing to turn the carbon monoxide to carbon dioxide, and further breaking it down to carbonate, and simply turning the nicotine into harmless thiamine (vitamin B complex). (“Labor Investigation Committee: Science of Smoking—Separation of Workplace for Smoker and Non-smokers” text book)

Table 4 is an extract of data from harmful substances in tobacco smoke (“Labor Investigation Committee: Science of Smoking—Separation of Workplace for Smoker and on-smokers” text book), and shows amount of harmful substance produced (calculated values) when smoking for one hour with example 4.

TABLE 4
Harmful substances in tobacco smoke

| Quoted in “Labor Investigation Committee: Science of Smoking - Separation of | | | | | | |
|---|---|---|---|---|---|---|
| workplace for smoker and non-smokers” text book” | | | | | | |
| Harmful substance | | Amount of harmful substance | | | Example 4 | |
| Gaseous phase | | produced from one cigarette | | | 36/144 m³ | 39/144 m³ |
| component (89.2%) | | μg | % | ppm | ppm | ppm |
| Carbon monoxide | CO | 20,000 | 78.7 | 20 | 5 | 5.4 |
| acetaldehyde | CH₃CHO | 1,400 | 5.5 | 1.4 | 0.35 | 0.38 |
| nitroxide | NOₓ | 600 | 2.4 | 0.6 | 0.15 | 0.16 |
| hydrogen cyanide | HON | 200 | 0.6 | 0.2 | 0.05 | 0.05 |
| ammonia | NH₃ | 150 | 0.6 | 0.15 | 0.04 | 0.04 |
| Particulate components | | | | | | |
| (10.8%) | | | | | | |
| nicotine | | 2,000 | 7.9 | 2 | 0.5 | 0.54 |
| catechol | | 460 | 1.8 | 0.46 | 0.1 | 0.12 |
| | | 200 | 0.8 | 0.2 | 0.05 | 0.05 |

Japan Electric Industry Association:

objects of measurement: acetaldehyde, ammonia, acetic acid

Acetic acid is also an object, but there is hardly any in tobacco smoke Nicotine is transferred to gaseous phase according to effect of ammonia included in tobacco, and normally passes through an air purifier. Harmful substances in tobacco smoke Labor Investigation Committee: Science of Smoking—Separation of Workplace for Smoker and Non-smokers” text book

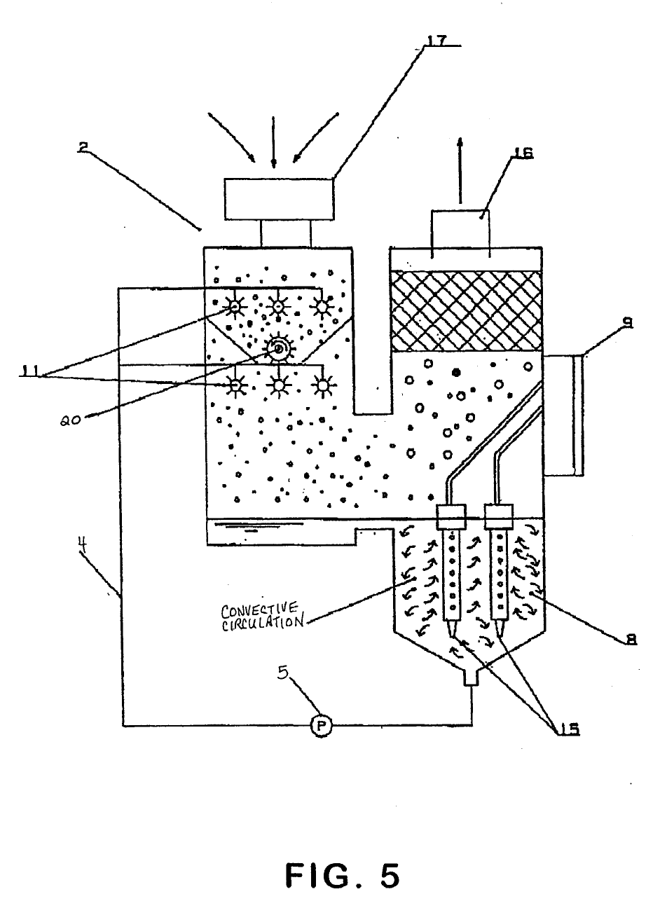

FIG. 5 is a flow drawing for a process of extracting air from a room that is contaminated with tobacco smoke towards an absorption means (deodorizing tower) 2 using a blower (attraction fan) 17, subjecting the contaminated air to oxidation processing and purification and sterilization with electrolytic sterilization and purification water and returning the purified air to the room, this drawing shows a cross section of the device. Electrolytic sterilization and purification water in the electrolytic circulation water receiving tank 8 is sprayed from the spray nozzle 11 by means of the water circulating line 4, and droplets are turned into an even finer mist by a rotating fin rotor 20 then brought into contact with the extracted air.

This device was installed in a smoking area of the Kansai District Headquarters of NM Ltd., and tested for one day at a managers training seminar. In a room having a floor space was 55 m² and a volume of 144 m³, 28 smokers smoked 36 cigarettes in a lunch break from 12 noon to 1 pm, and 30 smokers smoked 39 cigarettes during a rest period from 3 pm to 4 pm. An air purification test was then carried out for 20 minutes after each rest period. Measurement of concentration of harmful substances in the air was carried out at an intake port and at an exhaust port where purified exhaust gas was discharged. A gas measurement kit 801 made by Gastec Corporation was used. Acetaldehyde and ammonia could not be detected but carbon monoxide could be detected. Results are shown in Table 5.

It was possible to decompose and purify all of carbon monoxide, acetaldehyde and nitroxide. The room was photographed before and after testing, but due to the smoke in the room before the test the room was hazy, and it was not possible to read characters written on a white board 8 m diagonally away from the entrance. In the photograph taken after the test, smoke was removed and it was possible to read characters on the white board. Before the test, three female employees complained that the air in the room was so bad that it gave them a headache, but that after the test it had become much fresher, and that it felt much better.

TABLE 5

| | | | Before | 10 minutes | 20 minutes |
|---|---|---|---|---|---|
| | | | commencing | after | after |
| | | | electrolysis | electrolysis | electrolysis |
| Harmful gas | | | ppm | ppm | ppm |
| Carbon | CO | Lunch | 5.6 | 2.1 | 0 |
| monoxide | | break | | | |
| | | Rest | 6.3 | 3.2 | 0.1 |
| | | period | | | |
| Acetaldehyde | CH₃CHO | Lunch | 0.4 | 0.1 | 0 |
| | | break | | | |
| | | Rest | 0.5 | 0.2 | 0 |
| | | period | | | |
| nitroxide | NOₓ | Lunch | 0.2 | 0 | 0 |
| | | break | | | |
| | | Rest | 0.3 | 0 | 0 |
| | | period | | | |

### EXAMPLE 6

When there is a lot of alcohol vapor etc., that is produced at storage buildings of sake breweries and in whiskey and wine aging sellers, in an aging cellar, it is necessary to implement sufficient safety measures to ensure an ethanol concentration of 4,000-5,000 ppm. Also, ethanol concentration emitted by a ventilation fan (blower) is diluted at the blower and becomes less than 1,000 pp, but there is a problem that ethanol is condensed by surrounding trees and the trees die because of black mold that reproduces in the ethanol. With this example, decomposition and purification of ethanol in discharged air was carried out using the deodorization and purification device of FIG. 1. An electrolyte has a weight ratio of sodium chloride to sodium bromide of 8:2 and an electrolyte concentration of 3%. Two electrolytes were prepared, one with hydrochloric acid added in advance so that pH after electrolysis would be 6, and another with caustic soda added in advance so that pH after electrolysis would be 12.

500 cc of ethanol was placed in a 1 liter beaker wrapped in a band heater, the beaker placed in the exhaust gas or flue gas generating section 1 (sealed container: capacity 10 liters) of FIG. 1 and the thus produced gas fed into the absorption means (deodorizing tower) 2 by the blower (suction fan) 17. At the same time, ethanol was diluted by incoming air at a rate of 1 m³/min from an air intake port 17, so that the concentration became 1,000 ppm. Electrolysis was carried out with cells of the electrolytic reactor 3 arranged in parallel and with a constant current of 10A. With a residual chlorine concentration of the electrolytic water solution of 500 mg/L, and a circulatory flow rate of electrolytic water solution of 2 liters/min, ethanol was then mixed with circulation water of the water circulating water path 4 (circulatory flow rate of 10 liters/min) from the electrolytic water holding tank 8 and fed to the absorption means (deodorizing tower) 2.

Test results for the more acidic electrolyte are shown in Table 6, but since the residual chlorine amount in the electrolyte is high, chlorine gas was produced and after seven hours was 20 ppm in the exhaust gas. As shown by the test results in Table 7 for the more alkaline electrolyte, with this electrolytic condition, even though the residual chlorine concentration was high there was almost no generation of chlorine gas, and only 0.2 ppm was detected. The absorption rate at the absorption means (deodorizing tower) 2 was also high at 89-90%, the rate of electrolyzing ethanol in the circulating water was 30% or better, and it was possible to continue operation without adding any supplemental water.

TABLE 6
Acidic conditions pH 6

| | Residual | | | | | | | |
|---|---|---|---|---|---|---|---|---|
| | chlorine | | | | | | | |
| | concentration | | | | | | | |
| | Circulating | | | | Ethanol concentration in circulation | | | |
| | water | Ethanol concentration in | | | water | | | |
| Electrolysis | solution | exhaust gas | | | Before | After | Rate of | |
| time | receiving | Intake | Outlet | Absorption | electrolysis | electrolysis | decompo- | Chlorine |
| hours | tank mg/l | ppm | ppm | rate % | % | % | sition | gas ppm |
| 0.5 | 300 | 850 | 25 | 97 | 0.121 | 0.03 | 86 | 0 |
| 1 | 500 | 1,100 | 75 | 94 | 0.75 | 0.12 | 84 | 0 |
| 2 | 550 | 1,150 | 110 | 90 | 1.25 | 0.98 | 22 | 0 |
| 3 | 600 | 1,000 | 150 | 85 | 1.78 | 1.53 | 14 | 3 |
| 4 | 630 | 1,100 | 180 | 84 | 2.43 | 1.98 | 19 | 5 |
| 5 | 640 | 1,150 | 170 | 85 | 2.83 | 2.25 | 20 | 8 |
| 6 | 670 | 1,050 | 190 | 82 | 2.99 | 2.31 | 23 | 12 |
| 7 | 680 | 1,100 | 160 | 85 | 3.15 | 2.45 | 22 | 20 |
| 8 | 660 | 1,100 | 165 | 85 | 3.23 | 2.63 | 19 | 20 |
| 9 | 670 | 1,150 | 170 | 85 | 3.46 | 2.85 | 18 | 30 |

TABLE 7
Alkaline conditions pH 12

| | Residual | | | | | | | |
|---|---|---|---|---|---|---|---|---|
| | chlorine | | | | | | | |
| | concentration | | | | Ethanol concentration in cirulation water | | | |
| | Circulation | Ethanol concentration in | | | solution | | | Chlo- |
| Electrolysis | water | exhaust gas | | | Before | After | | rine |
| time | receiving tank | Intake | Outlet | Absorption | electrolysis | electrolysis | Rate of | gas |
| hours | mg/l | ppm | ppm | rate % | % | % | decomposition | ppm |
| 0.5 | 350 | 880 | 20 | 98 | 0.25 | 0.02 | 92 | 0 |
| 1 | 600 | 1,050 | 55 | 95 | 0.81 | 0.06 | 90 | 0 |
| 2 | 580 | 1,100 | 95 | 91 | 1.31 | 0.88 | 33 | 0 |
| 3 | 600 | 1,150 | 110 | 90 | 2.15 | 1.48 | 31 | 0 |
| 4 | 620 | 1,150 | 115 | 90 | 2.35 | 1.54 | 34 | 0 |
| 5 | 650 | 1,100 | 120 | 89 | 2.45 | 1.66 | 31 | 0 |
| 6 | 660 | 1,150 | 125 | 89 | 2.54 | 1.71 | 33 | 0 |
| 7 | 680 | 1,200 | 130 | 89 | 2.66 | 1.87 | 30 | 2 |
| 8 | 680 | 1,150 | 130 | 89 | 2.88 | 1.95 | 32 | 0 |
| 9 | 670 | 1,150 | 135 | 88 | 2.97 | 2.03 | 32 | 2 |

What is claimed is:

1. A method for deodorization and purifying exhaust gas or flue gas, comprising the steps of:
electrolyzing an electrolytic water solution that is a mixture of an alkaline electrolyte group and a neutral salt electrolyte group in an electrolytic reactor; and
bringing the electrolyzed electrolytic water solution into contact with the exhaust gas or flue gas.

2. The method as claimed in claim 1, including the step of diluting the electrolyzed water solution with tap water or irrigation water.

3. The method as claimed in claim 1, wherein the alkaline electrolyte group is selected from the group consisting of caustic soda, caustic potash, hypochlorous acid soda, and a mixture thereof, and the neutral salt electrolyte group is selected from the group consisting of sodium chloride, potassium chloride, sodium bromide, and a mixture thereof.

4. The method as claimed in claim 1, including the step of adjusting the pH of the electrolyzed electrolytic water solution to a pH of 8 to 13 in the electrolytic reactor.

5. A deodorization and purification device for exhaust gas or flue gas, comprising:
an electrolytic reactor for electrolyzing an electrolytic water solution that is a mixture of an alkaline electrolyte group and a neutral salt electrolyte group;
an absorber;
a water circulation path;
a circulation pump for feeding electrolyzed electrolytic water solution generated in the electrolytic reactor to the absorber via the water circulation path; and
a shower spray for introducing a shower of electrolyzed electrolytic water solution to the absorber.

6. The device according to claim 5, wherein the alkaline electrolyte group is selected from the group consisting of caustic soda, potash, hypochlorous acid soda, and a mixture thereof, and the neutral salt electrolyte group selected from the group consisting of sodium chloride, potassium chloride, sodium bromide, and a mixture thereof.

7. The device as claimed in claim, wherein the electrolytic reactor includes an anode formed of an electrically conductive metal with an electrically conductive ceramic or a vapor deposited or thermal sprayed film of an electrically conductive ceramic, or a vapor deposited or thermal sprayed film of diamond formed on a surface of the electrically conductive metal, and a cathode formed of an electrically conductive metal.

8. The device as claimed in claim 7, wherein the cathode is formed of stainless steel or titanium.

9. The method as claimed in claim 1, wherein the exhaust gas or flue gas contains a bad odor, smoke or oil film of grilled meat, grilled fish, deep fat frying or oil frying from a restaurant or foodstuff processing plant, cigarette smoke, or odors from ventilation of hospitals or elderly care facilities, human waste and refuse disposal sites, sewage treatment plants, and outgassing.

10. The method as claimed in claim 9, wherein the odors are selected from the group consisting of ammonia, hydrogen sulfide, methyl theoalcohol, hydrogen sulfide, methyl sulfide and acetaldehyde.

11. The method as claimed in claim 1, wherein the exhaust gas or flue gas contains an organic processing or washing solvent from a factory or plant, or alcohol vapor from a storage building of a sake brewery or an aging cellar for whiskey or wine.

12. The method as claimed in claim 11, wherein the organic solvent is selected from the group consisting of isopropyl alcohol, ethanol, toluene, xylene and benzene.

13. The method as claimed in claim 11, wherein the organic solvent comprises a halogen compound.

14. The method as claimed in claim 13, wherein the halogen compound comprises perchloroethylene or a fluon gas.

15. The method as claimed in claim 1, wherein the exhaust gas or flue gas is selected from the group consisting of a combustion exhaust gas, sulfur oxide, smoke, nitroxide, carbon monoxide, hydrocarbon soot and dust..
